(19) United States
(12) Patent Application Publication
(10) Pub. No.: US 2004/0249715 A1
(43) Pub. Date: Dec. 9, 2004

(54) Dining and drinking dice and method

(76) Inventors: Mark K. Niles, Chicago, IL (US); Lisa M. Fiorito, Chicago, IL (US)

Correspondence Address: R. Blake Johnston, Esq., PIPER RUDNICK LLP, P.O. Box 64807, Chicago, IL, 60664-0807, US

(21) Appl. No.: 10/829,508

(22) Filed: Apr. 22, 2004

Related U.S. Application Data
(60) Provisional application No. 60/464,624, filed on Apr. 22, 2003.

(51) Int. Cl. G06F 17/60

(52) U.S. Cl. 705/15; 463/22

(57) ABSTRACT

A set of dice and method for selecting between options relating to consumables such as food and drinks includes dice having information relating to the options printed thereon. For example, the set of dice may include first and second dice with the first dice featuring the type of cuisine and the second dice featuring the type of dining, restaurant type, restaurant location or restaurant name. Alternatively, the set of dice may include a first dice with types of drinks printed thereon and a second dice with types of bars printed thereon. The set of dice could also feature a first dice featuring bar or restaurant types printed and a second dice featuring bar or restaurant locations. The dice may also be used for advertising specific restaurants or bars and may be presented to obtain a discount at an establishment.

This application claims priority from U.S. Provisional Patent Application Serial No. 60/464,624, filed Apr. 22, 2003.

### BACKGROUND OF THE INVENTION

The present invention relates generally to entertainment products and, more particularly, to a set of dice and method for selecting dining or drinking options from a variety of alternatives.

People planning an evening out in a large city often are faced with a dizzying number of drinking or dining options. With regard to the latter, populous areas such as cities typically offer a large number of establishments offering a wide variety of cuisine types, locations and price ranges. To further complicate matters, people must decide whether they wish to dine in, which may include either carryout or delivery, or go out to a restaurant. The dining decision can thus be a difficult one to make and may result in conflicts between the individuals who will be dining. Indeed, the decision may actually be so burdensome that it destroys the fun of going out.

With regard to drinking, the choice may be between bar types, i.e. cocktail lounge, dance club, Irish pub, etc. Alternatively, once at a drinking establishment, an individual must select a type of drink to have, i.e. beer, wine, mixed drink, etc.

A demand always exists for new forms of entertainment. Game and novelty product manufacturers are always searching for products that interest and amuse consumers. Consumers are always searching for new ways to be entertained.

In addition, restaurants and drinking establishments are constantly looking for ways to improve business. Indeed, substantial sums of money are spent by such businesses on advertising and promotions that will increase patron traffic. Consumers who eat out often or frequent nightclubs and the like are also interested in saving money when they go out so that they can optimize the amount of entertainment for their hard earned dollars.

Accordingly, it is an object of the present invention to provide a system and method for quickly and easily selecting a drinking or dining option.

It is another object of the present invention to provide a system and method for entertaining individuals as they select a drinking or dining option.

It is another object of the present invention to provide a system and method for promoting a restaurant or drinking establishment.

It is still another object of the present invention to save consumers money when drinking or dining.

### SUMMARY OF THE INVENTION

The present invention is directed to a set of dice and method for selecting between options relating to consumables such as food and drinks. The set of dice includes at least first and second dice where the first dice features information including types of consumables and the second dice features information including establishment (restaurant and bar) information. The types of consumables may be types of cuisine and the establishment information may include types of dining, restaurant types, restaurant locations or restaurant names. Alternatively, the types of consumables may be types of drinks and the establishment information may include bar types. As yet another alternative, the information on the first dice may be bar or restaurant types and the information on the second dice may be bar or restaurant locations. The method includes rolling at least the first and second dice and observing the information displayed by the rolled dice as the options chosen.

The dice may be used in a method for advertising a restaurant or bar by selling advertising space on the dice to the bar or restaurant, producing a dice with the name of the bar or restaurant on the dice and distributing the dice with the name of the bar or restaurant thereon. Discounts on food and drinks at the bar or restaurant whose name is on the dice may also be made available to a customer presenting the dice with the name of the bar or restaurant thereon.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIGS. 1A and 1B illustrate the twelve sides of a pair of dice in an embodiment of the present invention;

FIG. 2 illustrates the six sides of a fast food dice in an embodiment of the present invention;

FIG. 3 illustrates the six sides of a carryout/delivery dice in an embodiment of the present invention;

FIG. 4 illustrates the six sides of a fine dining dice in an embodiment of the present invention;

FIG. 5 illustrates the six sides of an economy dice in an embodiment of the present invention;

FIG. 6 illustrates the six sides of a mid-priced dice in an embodiment of the present invention;

FIG. 7 illustrates the six sides of a restaurant type dice in an embodiment of the present invention;

FIG. 8 illustrates the six sides of a restaurant location dice in an embodiment of the present invention;

FIG. 9 illustrates the six sides of a bar type dice in an embodiment of the present invention;

FIG. 10 illustrates the six sides of a drink type dice in an embodiment of the present invention;

### DESCRIPTION OF THE PREFERRED EMBODIMENTS

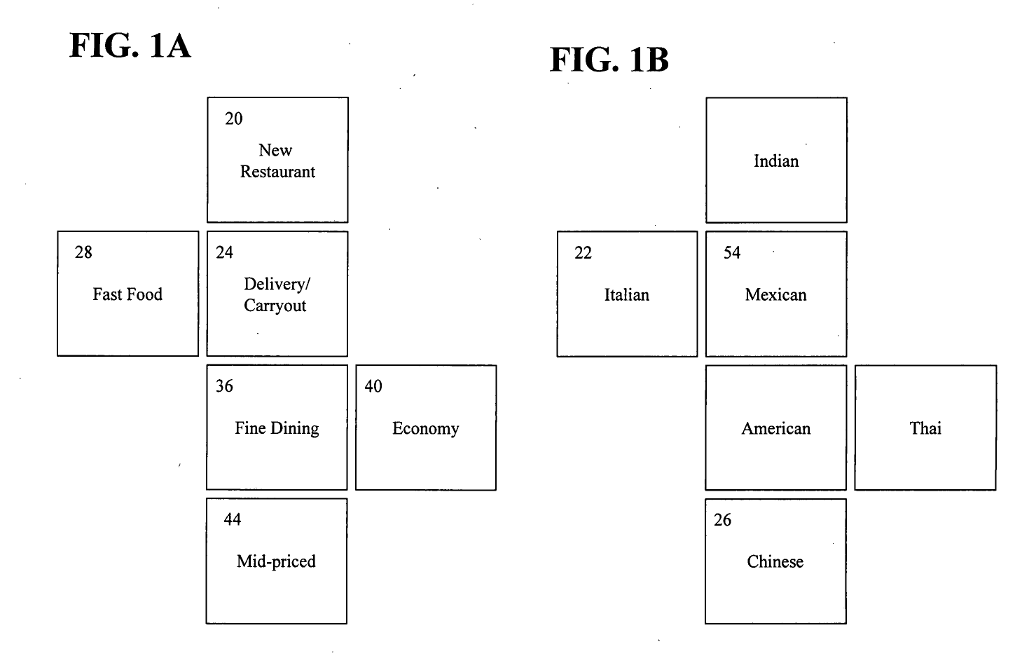

The present invention may be used to select between options relating to consumables, where the term “consumables” includes food and drinks. A pair of dice of an embodiment of the present invention are illustrated in FIGS. 1A and 1B. The dice are illustrated in an “unfolded” view so that all six sides of each dice are visible. In one embodiment of the method of the present invention, both dice are rolled simultaneously by a user to assist in deciding the type of dining and cuisine. For example, if side 20 of the dice in FIG. 1A and side 22 of the dice in FIG. 1B were rolled, the dining choice for the evening would be a new Italian restaurant. As another example, if side 24 in FIG. 1A and side 26 in FIG. 1B were rolled, the dining choice would be delivery or carry out Chinese food.

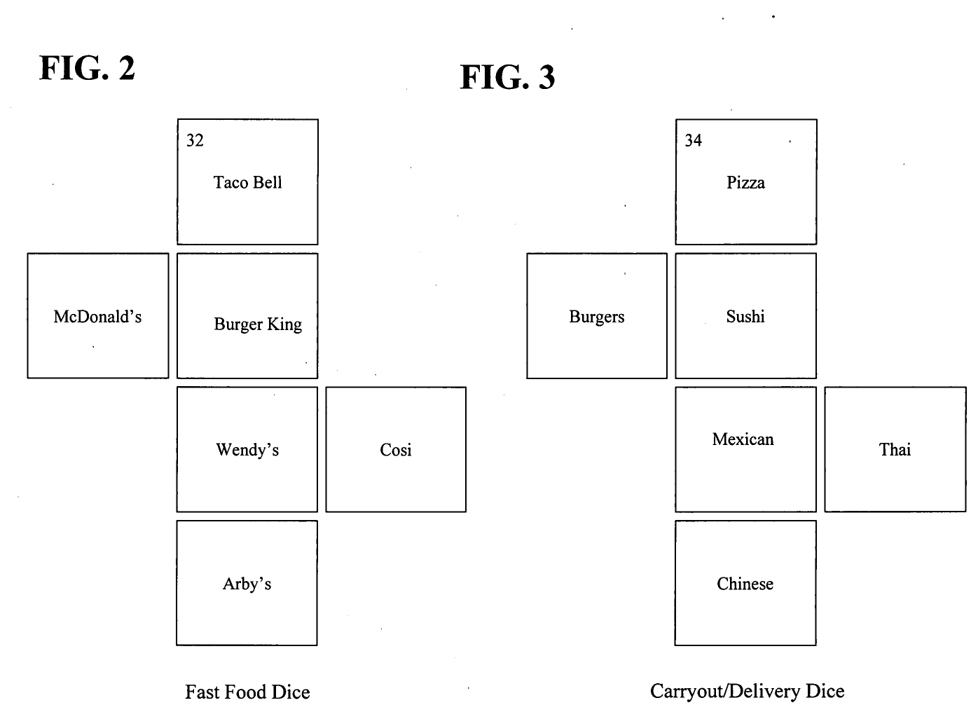

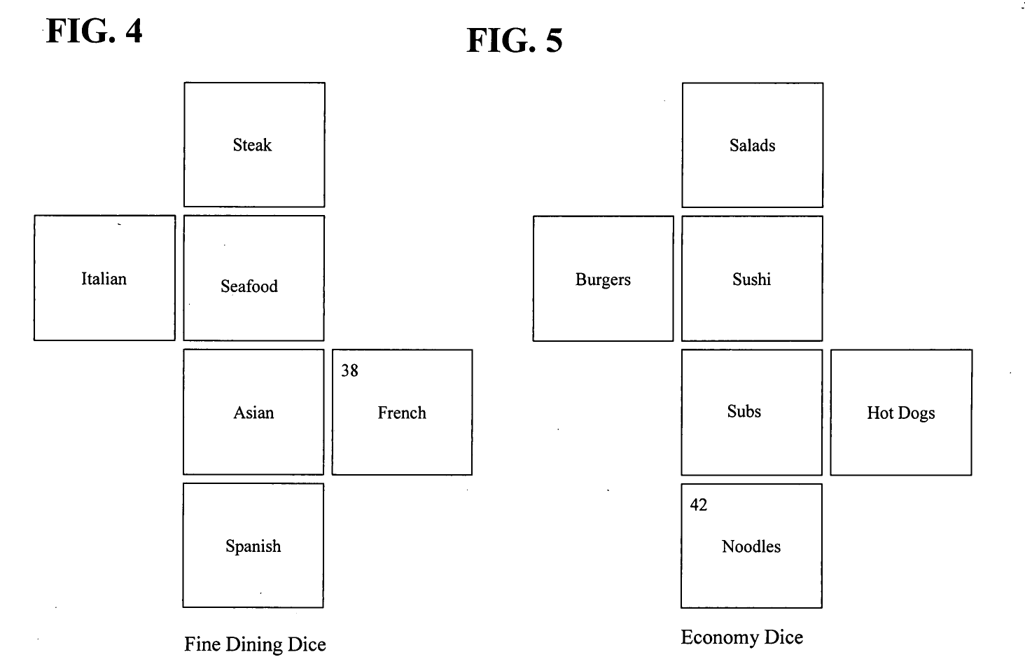

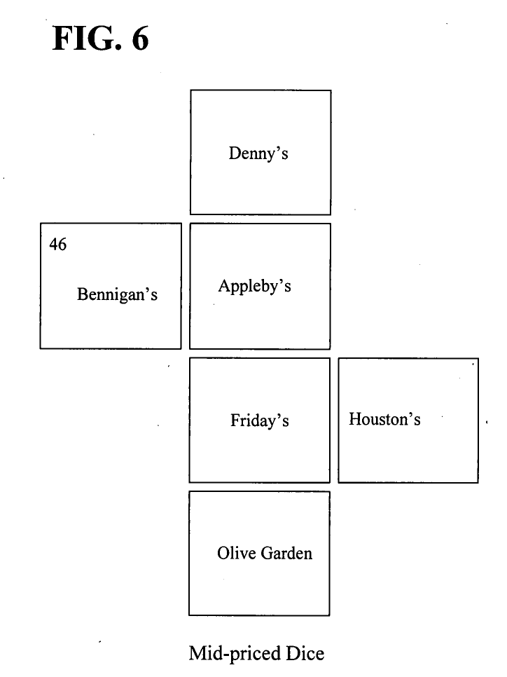

An alternative embodiment of the method of the present invention is to merely roll the dice of FIG. 1A by itself initially. Once this occurs, an appropriate second dice, selected from the remaining six dice of a set of seven dice, could be rolled. For example, if side 28 of the dice of FIG. 1A was rolled, that is, “Fast Food”, the dice of FIG. 2 would be rolled next. If, for example, side 32 of the dice of FIG. 2 was rolled, the dining choice for the evening would be a TACO BELL restaurant. If side 24 of the dice of FIG. 1A was rolled, the dice of FIG. 3 would be rolled next. If side 34 of the dice of FIG. 3 was rolled, the choice would be carryout or delivery pizza. If side 36 was rolled with the dice of FIG. 1A, the dice of FIG. 4 would be rolled next. If side 38 of the dice of FIG. 4 was rolled next, the choice would be a fine dining, French restaurant. If side 40 was rolled with the dice of FIG. 1A, the dice of FIG. 5 would be rolled next. If side 42 of the dice of FIG. 5 was rolled, the dining choice would be an economy, noodle restaurant. If side 44 was rolled with the dice of FIG. 1A, the dice of FIG. 6 would be rolled. If side 46 was rolled with the dice of FIG. 6, the restaurant choice would be a BENNIGAN'S restaurant.

The seventh dice of the set would list newly-opened restaurants on its six sides. If side 20 of FIG. 1A was rolled, the seventh dice of the set would be rolled so that one of the new restaurants would be selected. The seventh “new restaurant” dice offers a variety of marketing opportunities. For example, the set of dice could be offered as a premium for a subscription to a magazine relating to local restaurants and/or entertainment with a new “new restaurant” dice provided to the subscriber with each new issue of the magazine. Alternatively, a new dice could be issued independently on a weekly or monthly basis with or without the recipient paying a subscription fee.

Newly-opened restaurants may also pay the issuer of the dice to list their restaurant name on one of the dice sides. This would provide the restaurant owner with advertising and increased patron traffic. The restaurant owner may also provide a discount to patrons who bring the dice to the restaurant with them. As a result, the dice would act as a type of discount coupon for the patron.

Returning to the dice of FIG. 4, after the user rolls that dice, he or she could select the appropriate dice from an additional set of six dice with each dice listing restaurants serving a specific type of cuisine in a city. For example, one dice would be a Steak Restaurant dice and list steak restaurants on its sides. One dice would be a Seafood Restaurant dice and list seafood restaurants on its sides, etc. The same approach could be followed after the dice of FIG. 1B is rolled.

The dice listing specific restaurants would be specific to a particular city or area. As a result, the restaurant could pay a fee to be listed on the dice, as described earlier, for advertising purposes. Alternatively, the issuer of the dice could provide the user with monthly or weekly mailings that list recommended restaurants by cuisine type for reference by the user after rolling a cuisine or restaurant type with the dice. Restaurant owners could pay a fee to be included in the listings.

The dice could also be integrated with the Internet by listing a web site, for example, www.DiceDine.com, on a side of one of the dice. The web site could then provide the user with a restaurant choice for his or her particular city when the web site side is rolled with the dice.

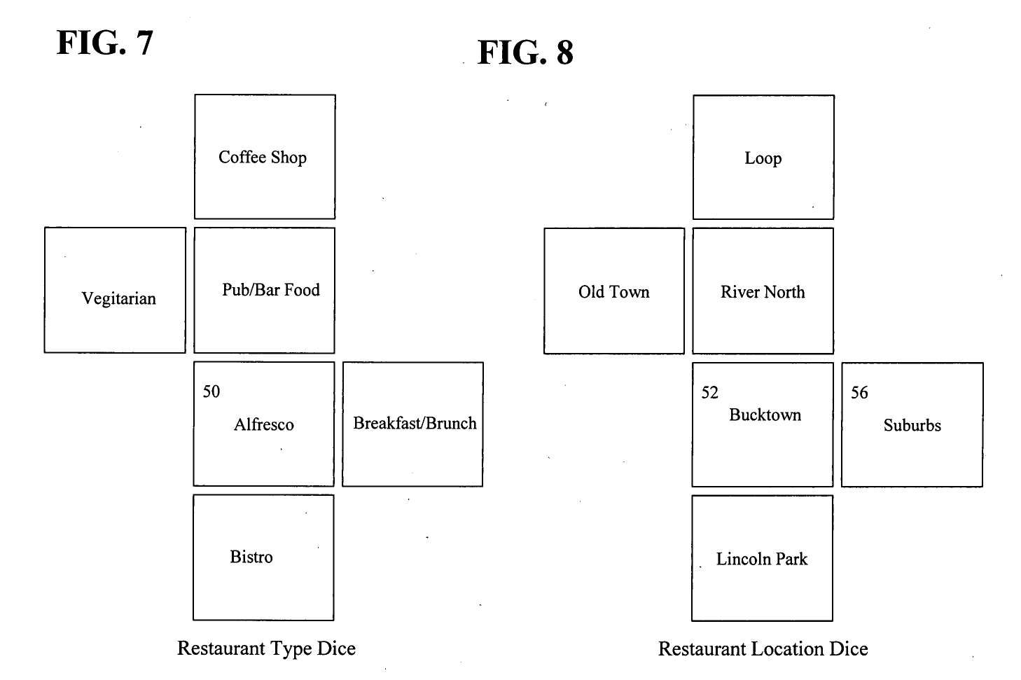

FIG. 7 and FIG. 8 illustrate alternative types of dice that list restaurant (or establishment) types and locations on their sides, respectively. These two dice could be rolled simultaneously. If, for example, side 50 was rolled with the dice of FIG. 7, and side 52 of the dice of FIG. 8 was rolled, the dining choice would be an alfresco restaurant in the Bucktown neighborhood of the city (in this case, Chicago, Illinois). The dice of FIG. 8 could also be rolled in combination with either the dice of FIG. 1A or FIG. 1B. For example, if side 54 of the dice of FIG. 1B was rolled in combination with side 56 of the dice of FIG. 8, the dining choice would be a Mexican restaurant in the suburbs. Of course, as stated above, an Internet web site, mailings, dice or other publications could list specific restaurant choices for consultation by the user for a fee paid by the restaurant owner.

An additional set of dice could be provided to assist in menu selections while at the restaurant. For example, the dice could list beef, fish, chicken, vegetarian, pasta and soup.

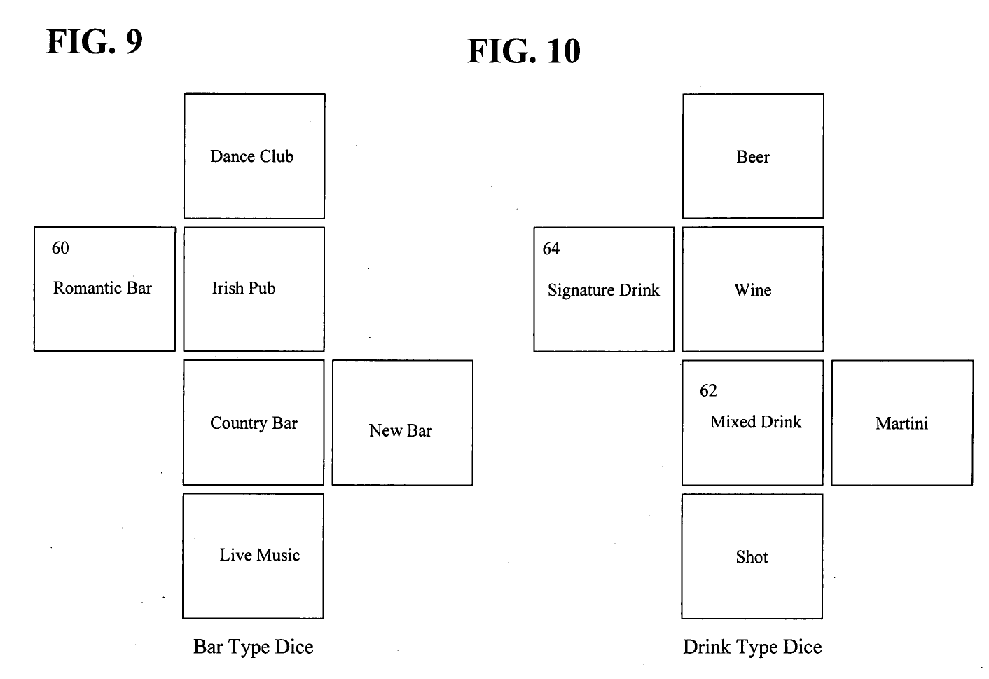

FIG. 9 and FIG. 10 illustrate dice that could be used to select a bar (or establishment) type and drink type. For example, if side 60 was rolled with the dice of FIG. 9 and side 62 was rolled with the dice of FIG. 10, the drinking choice would be mixed drinks at a romantic bar. Of course, the dice of FIG. 9 could be rolled with the dice of FIG. 8 to select a type of bar and location.

A bar or club dice could be issued for a specific city and rolled in combination with the dice of FIG. 10. The dice of FIG. 10 could optionally include a “Signature Drink” side, illustrated at 64. If side 64 of the dice of FIG. 10 was rolled, the signature drink of the bar or club rolled with the other dice would be the drinking choice. As with the restaurant dice, bar or club owners could pay a fee to be listed on the dice. In addition, the bar or club could offer the user a drink special when the dice are presented at the bar and club.

The dice of the present invention could be offered in the six-sided versions illustrated or may alternatively be offered in 8 or more sided configurations. For example, dice similar to those illustrated in U.S. Pat. Nos. 6,007,065 to Ress and D439,932 to Shillings could be used.

The dice of the present invention could feature a novel appearance to attract the attention of consumers and to increase the enjoyment of their use. For example, the dice could be stainless steel and slightly larger and heavier than traditional dice. Other possible materials for the dice include, but are not limited to, LUCITE, wood or crystal. The dice could also feature multi-colored sides. The dice could be provided with a fancy velvet, suede or leather carry pouch or case.

The dice may also be magnetized so that they may be positioned on a metal surface, such as a refrigerator door. The magnetized dice may also stick together for ease of carrying. This is particularly beneficial if the set includes more than two dice. For situations where the dice is not constructed of metal, the magnetizing could be accomplished by embedding magnets within the center of the dice or in the dice surface.

The dice of the present invention could also be implemented in an electronic format. For example, a device similar to a PALM PILOT or other handheld device with a display screen could be programmed with random number generator circuitry so that rolls of the dice are simulated by pressing a key on the device. The “sides” of the dice would then be displayed on the display screen of the device. Cards featuring the appropriate programming could also be sold where the card could be plugged, or the programming thereof otherwise loaded, into the handheld device.

The dice could be marketed in a variety of ways including through magazines or catalogs, novelty stores, Internet web sites, hotels, restaurant shows, casinos, and various merchants (i.e. TIFFANY'S, RESTORATION HARDWARE, CRATE & BARREL, etc.).

It should be noted that the present invention is not limited to the configurations of the dice illustrated in the figures, that is, the dice shown are examples only and alternative listings could be substituted for those illustrated. The key concept is that the dice provide drinking or dining options or consumable options (where consumables includes food and drinks) so that by rolling one or more dice, a drinking or dining option is selected by the user.

While the preferred embodiments of the invention have been shown and described, it will be apparent to those skilled in the art that changes and modifications may be made therein without departing from the spirit of the invention, the scope of which is defined by the appended claims.

What is claimed is:

1. A set of dice for choosing between options relating to consumables comprising:
a) a first dice featuring a first type of information relating to consumables; and
b) a second dice featuring a second type of information relating to consumables.

2. The set of dice of claim 1 wherein:
a) the first type of information on the first dice is types of consumables; and
b) the second type of information on the second is establishment information.

3. The set of dice of claim 2 wherein the types of consumables are types of cuisine and the establishment information includes types of dining.

4. The set of dice of claim 2 wherein the types of consumables are types of cuisine and the establishment information includes restaurants types.

5. The set of dice of claim 2 wherein the types of consumables are types of cuisine and the establishment information includes restaurant locations.

6. The set of dice of claim 2 wherein the types of consumables are types of drinks and the establishment information includes bar types.

7. The set of dice of claim 2 wherein the types of consumables are the types of cuisine and the establishment information includes restaurant names.

8. The set of dice of claim 1 wherein:
a) the first type of information on the first dice is establishment types; and
b) the second type of information on the second dice is establishment locations.

9. The set of dice of claim 8 wherein the establishment types are bar types and the establishment locations are bar locations.

10. The set of dice of claim 8 wherein the establishment types are restaurant types and the establishment locations are restaurant locations.

11. A method for selecting between options relating to consumables comprising the steps of:
a) providing first and second dice featuring a first type of information relating to consumables a second type of information relating to consumables, respectively;
b) rolling the first and second dice; and
c) observing the information displayed by the rolled first and second dice.

12. The method of claim 11 wherein:
a) the first type of information on the first dice is types of consumables; and
b) the second type of information on the second is establishment information.

13. The method of claim 12 wherein the types of consumables are types of cuisine and the establishment information includes types of dining.

14. The method of claim 12 wherein the types of consumables are types of cuisine and the establishment information includes restaurants types.

15. The method of claim 12 wherein the types of consumables are types of cuisine and the establishment information includes restaurant locations.

16. The method of claim 12 wherein the types of consumables are types of drinks and the establishment information includes bar types.

17. The method of claim 12 wherein the types of consumables are the types of cuisine and the establishment information includes restaurant names.

18. The method of dice of claim 11 wherein:
a) the first type of information on the first dice is establishment types; and
b) the second type of information on the second dice is establishment locations.

19. A method for advertising a restaurant or bar comprising:
a) selling advertising space on a dice to the bar or restaurant;
b) producing a dice with the name of the bar or restaurant on the dice; and
c) distributing the dice with the name of the bar or restaurant thereon.

20. The method of claim 19 further comprising the step of offer a discount on consumables at the bar or restaurant whose name is on the dice to a customer presenting the dice with the name of the bar or restaurant thereon.
